(19) United States
(12) Patent Application Publication
(10) Pub. No.: US 2015/0369694 A1
(43) Pub. Date: Dec. 24, 2015

(54) BLUNT IMPACT INJURY MODEL SYSTEM

(71) Applicant: THE SECRETARY OF STATE FOR DEFENCE, Wiltshire (GB)

(72) Inventors: MICHAEL STUART NEALE, SALISBURY, WILTSHIRE (GB); LUCY SARAH ALLANSON-BAILEY, SALISBURY, WILTSHIRE (GB)

(21) Appl. No.: 14/764,265

(22) PCT Filed: Jan. 31, 2014
(86) PCT No.: PCT/GB2014/000035

§ 371 Date: Jul. 29, 2015

(30) Foreign Application Priority Data
Jan. 31, 2013 (GB) 1301709.0

(51) Int. Cl. G01M 7/08; G01L 5/00

(52) U.S. Cl. CPC G01M 7/08; G01L 5/00

(57) ABSTRACT

The present application is concerned with a system for assessing injury risk or damage to an object in response to a blunt impact, and especially skull fracture risk beneath a helmet in response to a blunt impact. The application is also concerned with the use of a force sensor for evaluating the response of materials for use in a helmet shell to a blunt impact.

The present application is concerned with models and methods for assessing injury risk or damage in response to a blunt impact, and especially skull fracture risk beneath a helmet in response to a blunt impact.

Although protective equipment/garments may prevent serious and fatal injuries from blunt impacts and penetrating projectiles (e.g. fragments), there is still a risk that damage may occur to the equipment/garment, and consequently injury. For example, a helmet may prevent serious and fatal head injuries from blunt impacts and penetrating projectiles, but it is still possible for the helmet wearer to be severely or fatally injured as a consequence of deformation of the helmet shell. As the helmet dynamically deforms, the inner surface of the helmet shell can impact the head, causing serious or fatal head injuries. This injury risk is referred to as head Behind Armour Blunt Trauma (BABT). It is speculated that the risk of head BABT may increase in the future with the growing interest in the use of new lightweight flexible armour materials in the construction of helmets; which may reduce the likelihood of ballistic threats perforating a helmet system, but helmets made from such materials may exhibit greater amounts of deformation when impacted. The concern is that the risk of head BABT may increase with the use of these flexible materials in future helmet designs.

Biokinetics Limited has developed a ballistic load sensing headform system for assessing the head BABT risk for helmets impacted by ballistic threats. The headform enables a direct measurement of the dynamic loads imparted to parts of the human skull by deformation of a helmet caused by non-penetrating projectiles. The forces can be correlated to the risk of skull fracture. However, this system is only capable of evaluating the risk of injury at a maximum of three specific fixed positions/areas of the skull: at the front, side and rear of the skull. Many areas of the skull cannot be evaluated for the risk of BABT.

Consequently there are no recognised standards or models capable of assessing the ability of helmets to protect all points of a human skull against BABT. This is a shortcoming, especially as a system evaluating the complete skull, would potentially be able to evaluate all weaknesses in a helmet design, which may elevate the risk of BABT. Also a system capable of evaluating the comprehensive abilities of a helmet to protect against BABT could be used to design optimised helmets. In particular, a system capable of evaluating the BABT fracture risk to the complete skull could be used to design helmet systems optimised to the injury tolerance (strength) of the skull that could yield possible improvements in protective performance of helmets and reductions in the burden (weight) that they place on the wearer.

Without an appropriate means of assessing the risk of BABT, helmets will inevitably have to be over-designed to compensate for uncertainties over the potential injury risks. This could, for example, lead to helmets being bulkier and heavier that they need to be to provide optimum protection.

The objective of the invention of the present application is to provide an improved means of assessing the risk of damage/injury to an object, such as the human skull, from blunt impact conditions, and especially BABT to the skull, to enable assessment of the protective efficacy of garments, especially helmets, and facilitate the development of garments (helmets) with improved protection and/or reduced mass.

In a first aspect the present invention provides a system for assessing the risk of injury or damage to an object in response to blunt impact, the model comprising a hollow shell, having an inner surface and an outer surface, defining the shape of the object, and a force sensor displayed at or beneath the inner surface of the hollow shell, wherein the force sensor is moveable to circumscribe the whole or a substantial part of the inner surface of the hollow shell to record a force at a point or area on or beneath the hollow shell.

The object could be a protective garment, or a part thereof, such as armour or a helmet. The object could also be a skull, such as a human skull, or a part thereof. In addition to the shape of the object, the hollow shell may include other properties of the object of interest, especially those properties enabling the hollow shell to more reliably imitate or mimic the object of interest, such as providing a hollow shell with similar compositions to the object of interest, or of similar thicknesses between the inner and outer surface of the hollow shell.

In one embodiment of the first aspect the model system is a blunt impact head injury model (BIHIM) system for assessing skull fracture risk beneath a helmet in response to blunt impact; the model comprising a hollow shell, having an inner surface and an outer surface, defining the shape of a human skull, or a part thereof, to support the helmet, and a force sensor displayed at or beneath the inner surface of the hollow shell, wherein the force sensor is moveable to circumscribe the whole or a substantial part of the inner surface of the hollow shell to record a force at a point or area on or beneath the hollow shell.

This head model system can potentially be used to assess the BABT risk of complete helmet systems to any part of the human skull selected for evaluation.

Though a system displaying sensors about the entire hollow shell was initially considered as a solution to provide an assessment of injury to any point on a part of the human skull, it gradually became apparent that the design and manufacture of such a system would be highly complicated, problematic and intricate, require great expense, and would not guarantee success.

The Applicant has largely overcome the above mentioned issues, and provided an improvement over known systems, through a system which includes a force sensor capable of movement about the whole inner surface of a hollow shell, or a substantial part thereof, wherein the hollow shell has the shape of the human skull, though the hollow shell could have the shape of any object for which an assessment of the risk of damage or injury from blunt impact is required

The hollow shell preferably defines parts of the human skull most at risk from injury beneath a helmet in response to a blunt impact. The shape of the hollow shell may for example define at least the frontal bone and the parietal bone, or a substantial part thereof, of the human skull, or at least the neurocranium, or a substantial part thereof, of the human skull. The hollow shell may be an artificial human skull.

The hollow shell is preferably comprised of materials able to transmit loads to the force sensor. The hollow shell may for example comprise high impact polystyrene (HIPS), polyester terephthalate glycol (PETG), acrylonitrile butadiene styrene (ABS), polypropylene (PP), or polyvinyl chloride (PVC).

For providing a more realistic model for injury to the human skull the hollow shell may comprise materials of composition and/or thicknesses to mimic the human scalp.

The shape of the hollow shell when defining parts of the human skull is preferably in accordance with an ISO standard head form, such as the ISO “J” size head form.

The force sensor is preferably mounted on a moveable arm, and is preferably enclosed within the hollow shell. Such a moveable arm should be arranged such that the impact face of the force sensor can be located at any point or area at or beneath the inner surface of the hollow shell, providing a capability to assess damage or injury risk to the object, and especially any point or area on the inner surface of the hollow shell, thus potentially representing any point or area on a part of the human skull.

The moveable arm is preferably capable of five degrees of freedom of movement, and most preferably six degrees of freedom of movement.

The six degrees of freedom are those of translation [moving up and down (heaving); moving left and right (swaying); moving forward and backward (surging)] and rotation [tilting forward and backward (pitching); turning left and right (yawing); tilting side to side (rolling)].

The force sensor may be a load sensor, or may comprise an array of force sensors, and could be a load cell array, such as seven load cells mounted in a hexagonal arrangement. A load cell is a transducer that is used to convert a force into an electrical signal.

The moveable arm is preferably designed such that the impact face of the force sensor or load cells can be located at any point or area at or beneath the inner surface of the hollow shell, and may be capable of being locked in the desired position.

The impact face of the force sensor or load cells may comprise a rubber pad, such as a silicon rubber pad, to improve the biofidelic response of the model system, in particular to more accurately mimic the response of the human skeleton, such as human skull and scalp, to a blunt impact.

The probability of injury, i.e. skull fracture, may be predicted from the force recorded, by use of standard correlation curves that have previously been produced, such as an injury risk curve.

In a second aspect the present invention provides the use of a force sensor for evaluating the response of a substantially flat sample of material to a blunt impact to enable selection of materials suitable for use armour such as in a helmet shell, wherein the flat sample of material has an inner surface and an outer surface and is arranged to experience a blunt impact to the outer surface, and the force sensor is displayed at or behind the inner surface to record a force at a point or area on or behind the flat sample of material.

The Applicant has devised a simple and quick method by which materials for use in the shell of a helmet can be down selected, by testing the response of the materials to a blunt impact. The force sensor could be a load cell array such as a flat plate load cell array, and can be arranged such that it is in contact with the inner surface of the flat sample of material, or can be arranged so that it is situated at a distance from the flat sample of material: a system or device could comprise a force sensor which can be moved in a controlled manner towards or away from the inner surface of the flat plate of material. Advantages of such a system would be that the optimum stand-off of a specific helmet material from the human skull could for example be calculated, and thereby aid in the design of new helmets.

Such a system may also be able to assess other helmet design features, such as the liner and padding within a potential helmet shell.

The flat plate load cell array may comprise seven load cells mounted in a hexagonal arrangement.

The present invention will now be described with reference to the following non-limiting examples and drawings in which

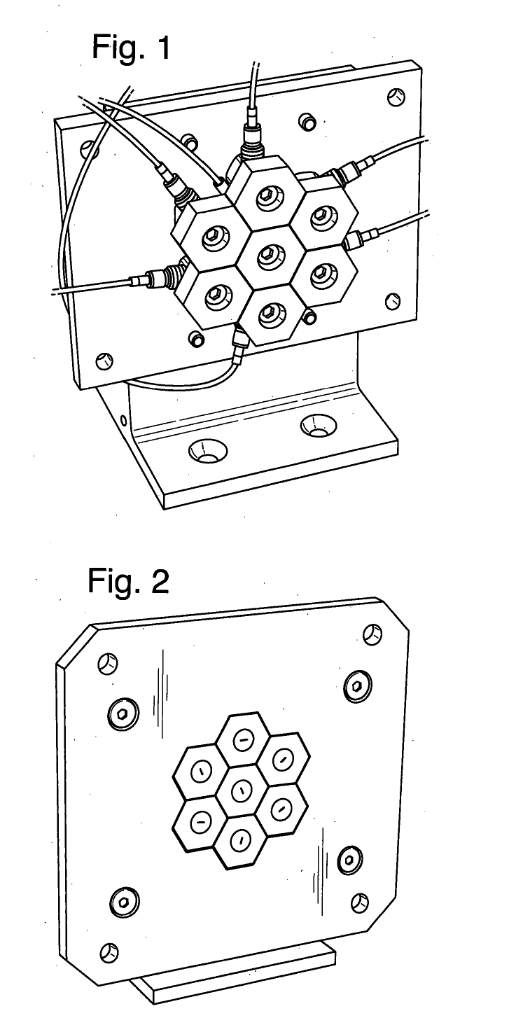

FIG. 1 is an image of the hexagonal arrangement of load cells within a flat plate load cell array for evaluating the response of flat samples of material to blunt impact;

FIG. 2 is an image of an external view of the flat plate load cell array of FIG. 1;

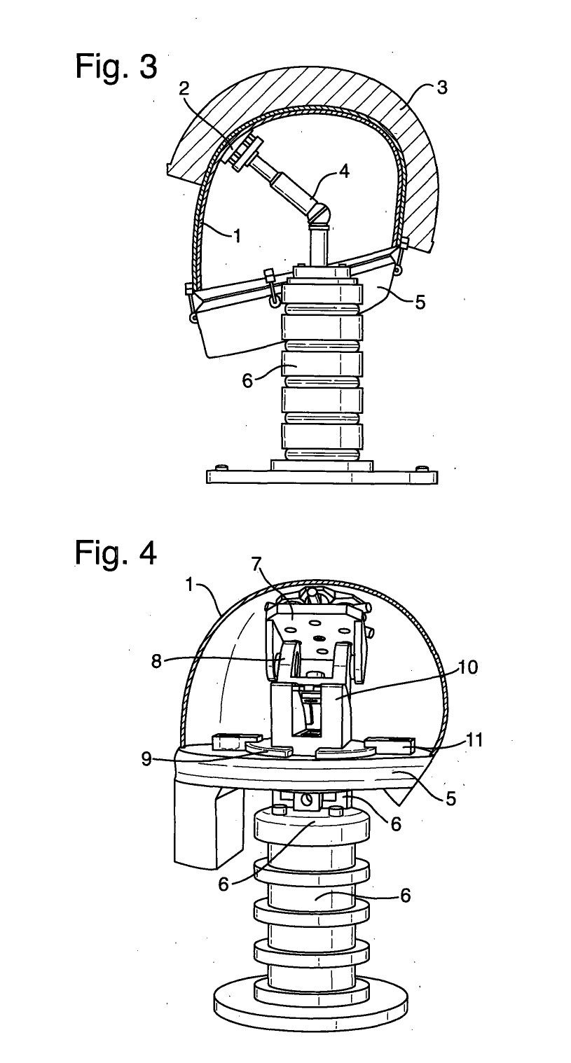

FIG. 3 is an illustration of the Blunt Impact Head Injury Model system;

FIG. 4 is an image of the Blunt Impact Head Injury Model system;

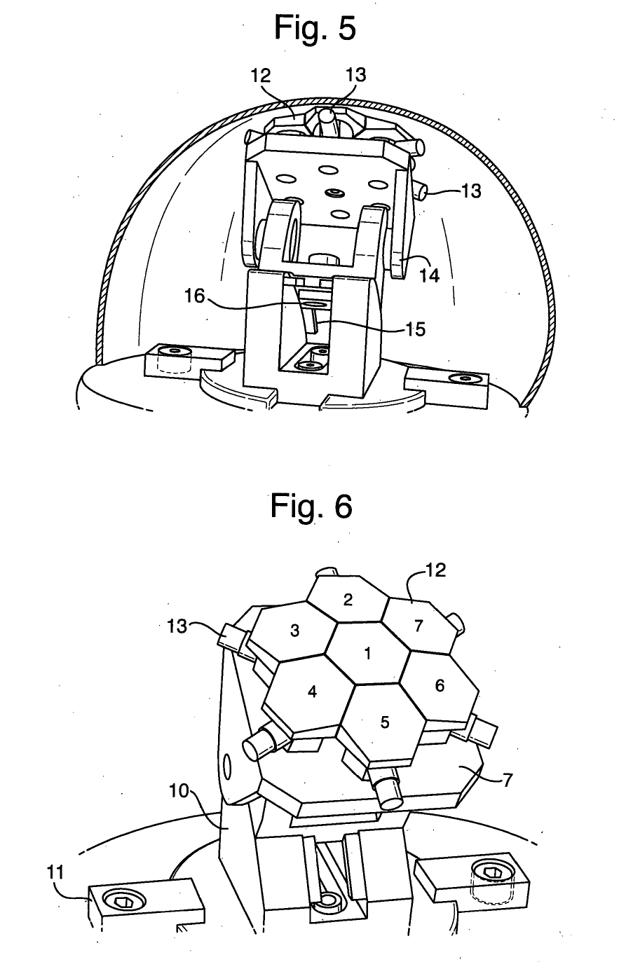

FIG. 5 is an enlarged view of the image of FIG. 4; and

FIG. 6 is an image of the load cell array on the moveable arm of the model system of FIG. 4.

### DEVELOPMENT OF A MODEL TO ASSESS THE RISK OF BABT TO THE HEAD

Skull fracture is an injury that has the potential to cause subsequent damage to vessels and tissues directly below the surface of the skull. However the full compliment and types of injuries that can occur under BABT loading conditions is not certain. Information is available providing an understanding of the fracture risk of the skull under blunt impact loading conditions. Consequently it was considered that skull fracture should be used as a principal indicator of head BABT and, as such, the BABT head model should assess the risk of skull fracture.

Studies were carried out to appreciate how changes in helmet design may affect BABT loading conditions. An examination of a selection of helmets, used as targets in ballistic tests, found that the following factors could have a considerable effect on the amount and shape of permanent (and assumed dynamic) deformation of the helmet shell:
The helmet (e.g. size, shape and material properties, etc.);
The type of projectile (e.g. size, mass, impact velocity, impact direction, etc.);
The system on which the helmet is mounted;
The design and structure of the helmet liner.
The head (e.g. size, injury tolerance etc.).

There are also many dynamic dependencies and interactions between the above variables that can influence the head BABT injury risk. For example, the size and shape of the helmet and head will affect the available stand-off, or the characteristics of the projectile and helmet will affect the size and effective mass of the structure impacting and injuring the head. It was, therefore important that a BABT head model should be able to consider these variables and account for the dynamic interactions in its predictions.

A review of past, current and potential future military helmet designs was carried out. This was used to identify variations in the design features of the helmets (such as the geometry of the helmet and the position of buckle attachments) that could influence the risk of head injury and the potential implications that these features may have on the design of a system for assessing head BABT.

Considerable variations were found in the designs of the helmets with regard to their shapes, the materials used in their construction and the location of fixtures and fittings for harnesses. It was anticipated that these variations would have a considerable effect on injury risk.

It was determined that a model for assessing head BABT should:
Represent the size and biofidelic response of the head to accurately represent the BABT loading conditions which will help to deliver the most accurate predictions of head injury;
Assess the BABT injury risk of the full helmet system (i.e. shell, liner and suspension system) to comprehensively assess the protective performance of the helmet;
Evaluate the BABT injury risk at any point on the head covered by the helmet to ensure that all potential weaknesses in the helmet design can be tested.

There were no BABT head models that could deliver on all of the design requirements. Consequently work was pursued to develop a purpose designed BABT head model.

Models developed for assessing BABT typically use a combination of a synthetic physical model and an injury risk curve (empirical model) to predict BABT injuries. Compared to other types of models available (e.g. biological and numerical) the development of a combined physical/empirical BABT injury model was considered the most practical, reliable, repeatable and cost effective means of determining how the helmet, projectile and head would influence the risk of head BABT.

Empirical BABT Head Model

Historical work has investigated the tolerance of the skull to fracture. In the majority of this work peak impact force was used to develop statistically significant skull injury risk functions and criteria.

Global acceleration of the head was previously considered as a metric for predicting skull fracture, however, this was found to be a poor metric for predicting fractures under BABT loading conditions. Previous work also found that the Blunt Injury Criteria (BIC) provides a more statistically accurate metric for predicting skull fracture than peak impact force. However, the BIC considers only the pre-impact conditions for skull fracture (i.e. the size, mass and velocity of the impactor and target). In the study developing a skull injury risk function based on BIC the projectile used was a rigid cylindrical aluminium impactor and the pre-impact conditions could be precisely determined. It is questionable whether accurate estimates of the pre-impact BABT loading conditions could be determined given the complex dynamic interactions that can occur between the helmet, projectile and head under BABT loading conditions.

Peak impact force consequently provides the most obvious basis for an empirical BABT injury model. It was, therefore, necessary that the physical BABT head model should be capable of measuring the impact force between the helmet and the physical head model. There was a considerable amount of historical data relating peak impact force to the skull fracture response, but this data was not generated under BABT loading conditions. Rigid flat impactors were used in many of the studies, with shapes, sizes, masses, stiffnesses and impact velocities different from the prospective structures causing BABT injuries. The fracture response of the skull is sensitive to these differences. For instance, in earlier reviews and studies presented in the published literature reference is made to the effect that loading area and rate have on the fracture tolerance of the skull. Previous injury risk curves based on skull fracture may, therefore, provide an indicative predictor of BABT injury, but there is substantial scope to improve the accuracy of these empirical models.

Synthetic Physical BABT Head Model

A review of potential load sensors to use in the BABT head model was carried out. Some existing head models use piezoelectric load cells in their designs, but the purpose of the review was to understand if there were better and more cost effective alternatives. Of the six possible candidate sensor systems considered piezoelectric load cells and fibre optic sensors were the most promising technologies on which to develop a physical BABT head model.

Load cells are used in other head model designs but there is a lack of information on the suitability and best approach for implementing this sensor technology in a BABT head model. There was, therefore, a need to evaluate the use of load cells in a BABT head model and this was achieved through the development of a flat plate Load Cell Array (LCA).

Fibre optic sensors are a new unproven approach on which to develop the force measuring capabilities of a BABT head model. There are prospects for these sensors to be cheaper, smaller and more robust than load cells, however considerable development work is required. There are obviously greater risks with this approach, but potentially greater benefits in pursuing the use of fibre optic sensors in the head model design. Hence, in addition to investigating the use of load cells, work was carried out to develop a fibre optic force sensor as an alternative or hybrid means of measuring the load response between the helmet shell and head.

Development of a Flat Plate Load Cell Array (LCA)

The flat plate LCA was developed to provide a basic system to evaluate the suitability of using load cells in a BABT head model design. There were also prospects to exploit the LCA to:
Investigate the effect that isolated helmet design features (e.g. stand-off and the material properties and structure of helmet shells, liners and pads) may have on the risk of head BABT;
Determine the V50 of helmet laminates impacted with representative threats (i.e. with a head surrogate backing);
Benchmark the performance of alternative sensor technologies, such as the fibre optic load sensors;
Assess the injury potential of weapon systems and the benefits that other personal protective equipment may offer in protecting from ballistic threats (e.g. face protection).

Design of the Flat Plate LCA

Having regard to FIG. 1 and FIG. 2, seven load cells are used in the LCA design, positioned and configured according to the arrangement of the seven hexagons; the hexagons represent the size of the individual loading plates fixed to the impact side of each load cell. Each loading plate has peripheral edge lengths of 11.5 mm and the foot print of the seven loading plates spans a diameter of approximately 7 cm. The distance between the centres of neighbouring load cells is 23 mm. The LCA is designed so that helmet material samples can be fixed between sandwich plates. The diameter of the hole in the sandwich plates has been set at 15 cm which was considered adequate to limit the effects of boundary conditions (attached periphery) on the BABT loading response of the material. The position of the sandwich plates can be adjusted with respect to the front of the load cell array so that representative variations in helmet stand-off (between the head and helmet) can be simulated with the model and so that different thicknesses of helmet padding and liners can be assessed with the rig. Also a replaceable 12 mm thick silicon pad of rubber (40 Shore A hardness) is placed over the impact face of the loading plates to represent the scalp and improve its biofidelic response.

The LCA was designed so that it can be attached to the neck of the Hybrid III crash test dummy and its mass approximates to that of a real head (ie approximately 4.5 kg). These features of the LCA design were considered important so that the LCA could be tested under comparable conditions to those under which previous BABT head models have been tested.

Alternative approaches for the design of the LCA were considered. These included the use of smaller load cells in order to increase the resolution; ie increase the ability to detect variations in loading force across the array. However to achieve the same surface area of coverage with the smaller load cells would have required approximately 44 load cells compared with the seven used in the current set-up. The cost (ie ˜£40 k) as well as the technical challenges to develop an array with this number of load cells was prohibitive (ie channel numbers, weight, weakness of the mounting plate drilled with numerous holes close together to accommodate the load cells).

A series of ballistic trials were carried out with the LCA leading to progressive improvements to enhance its robustness and performance.

The LCA load cells were brought closer together (by approximately 5 mm) and the size of the load cell loading plates were reduced by the same amount. This change was implemented to reduce the risk of bending moments, introduced by the excessive overhang of the loading plates with the load cells, causing damage to the load cells.

An adhesive was used to lock the screw fixings for the load cells and loading plates to prevent them from working loose when impacted.

High grade aluminium was used in the design of the loading plates to reduce their weight and therefore improve the response of the load cells.

Improvements in the LCA design were carried forward into the design for the BABT head model system.

Ballistic trials with the LCA were used to:
Evaluate and improve the robustness of the LCA design;
Improve the biofidelic response of the LCA;
Develop the ability of the LCA to predict BABT injuries;
Assess the effect that helmet design features may have on the risk of head BABT.

The principal objectives and conclusions from the trials were as follows:
The changes made to the LCA design mitigated the risk of it being damaged under BABT loading conditions.
The type and thickness of synthetic material to use for the LCA scalp was investigated. Also two alternative means of mounting the LCA were investigated; either fixed to the Hybrid III neck or freely suspended. Of the materials tested (silicon rubber and Sorbothane) a 12 mm thick layer of silicon rubber (40 Shore A hardness) was found to provide the best material to represent the scalp. The change in mounting method for the LCA had a subtle rather than large scale influence on the LCA force measures. It was determined that attachment to the Hybrid III neck would provide an appropriate method of mounting the LCA. Both these results (synthetic scalp and mounting method) were carried forward into the design for the BABT head model
Peak impact forces measured with the LCA were plotted against data from published Post Mortem Human Subject (PMHS) trials generated under comparable impact conditions. There was considerable overlap of the LCA measurements with the PMHS data. It was concluded that the injury risk curve previously developed with the PMHS data could be used with measurements from the LCA to predict skull fracture. The models can potentially be used to optimise the protective benefits of helmet systems according to the vulnerabilities of the human skull. For example, overall reductions in helmet mass could be achieved if the strength and weight of a helmet could be reduced in those regions covering the parts of the skull with the greatest tolerance to injury.
A trial was carried out to investigate the effect that stand-off and material type had on the likely BABT injury risk for two laminates. Nine millimetre steel ball bearings were fired at the laminates at velocities which caused maximum laminate deformation without perforation. It was found that the type of material and amount of stand-off (between 10 mm and 20 mm) have a considerable effect on the risk of BABT for this threat. The trial provided a useful demonstration of how the LCA can be used to down select helmet design features (e.g. stand-off and the type and construction of material to use for the helmet shell, liner and padding) prior to their formal introduction in a helmet design.

The flat load cell array and associated system/device for evaluating stand-off between head and helmet provides a very simple and uncomplicated system for evaluating helmet materials and design features.

Development of the BABT Head Model Skull Shell

Potential materials, with thicknesses of approximately 1 mm, that could be used in the construction of the skull shell included:
High Impact Polystyrene (HIPS);
Polyester Terephthalate Glycol (PETG);
Acrylonitrile Butudiene Styrene (ABS);
Polypropylene (PP); and
Polyvinyl Chloride (PVC).

Tests were carried out on the samples to investigate the effect that they would have on the force measures from the BABT head model if they were used in the skull shell design. The concern was that the material samples may shield the loading to the BABT model and adversely affect the sensitivity and accuracy of the model to predict injuries.

In the tests the LCA was used as a target for non-lethal weapon impact rounds, conditioned at 21° C. (impact velocity of between 69 m/s and 76 m/s). The severity of these impact conditions was considered representative of head BABT loading conditions. Baseline tests were initially carried out in which the impact face of the LCA was covered with a 12 mm thick pad of silicon rubber only. Following these baseline tests, subsequent tests involved the addition of a single sample of a prospective skull shell material between the silicon rubber and the impact face of the LCA. It was found that none of the potential materials tested had an adverse effect on the peak force measures from the LCA. Based on these results it was decided to manufacture the skull shell from Polypropylene. The skull shell was designed to have the same size and shape as the “J” ISO head form, which was found to best represent 50^{th} percentile anthropometric head data for military personnel.

The Head Injury Model System Design Concept

Having regard to FIGS. 3, 4, and 5, based on the requirements listed above, the design concept developed for the BIHIM consisted of an array of force sensors 2 mounted on a moveable arm 4. Enclosing the arm and sensors is a skull shell 1 with adequate strength to support a helmet 3, but flexible enough to transmit loads to the array under concentrated loads typically experienced under BABT loading conditions. The skull shell and moveable arm are fixed to a solid base 5 mounted on top of the Hybrid III Anthropometric Test Device (ATD) neck 6. Having regard to FIGS. 4, 5 and 6, the array of force sensors in one embodiment comprises load cell plates 12 fixed onto load cells 13, and mounted on to a load cell mount 7.

Computer Aided Design (CAD) was used to finalise the design using the design concept as a template for these developments.

The salient features of the design are that:
Many of the components have geared teeth to lock the assembled structure and prevent relative movement/slippage between the separate components when exposed to ballistic impacts. Having regard to FIGS. 4, 5 and 6, in one embodiment the system comprises geared bracket 8, geared base plate 9, and geared angle mount 10, all fixed and locked together by a clamp bolt 14, clamp bar 15, clamp nut 16, and base plate clamp 11.
The shape of the skull shell is based on the external profile of the “J” size ISO head form, which is typically used to assess the bump protection of military helmets. The moveable arm in the design provides the potential flexibility to assess the BABT injury risk of different head sizes, and at any point on the skull for each of those head sizes. However, for the purpose of developing an initial proof of concept and to harmonise the procedures for testing the bump protection and BABT risk from helmets, the “J” size ISO head form was chosen as the initial template to represent the external profile of the shell.
The size and shape of the base is taken from the lower part of the “J” size ISO head form. This is used to provide a suitable mounting point for helmet chin and nape straps.
The base is designed to fix to the neck of the Hybrid III dummy. Details of the relative anatomical positioning of the Hybrid III head on the Hybrid III neck was used to accurately define the neck fixture point for the BIHIM.
Blanking Discs are fixed over the bolt holes for the Load Cell Plates to prevent the bolts providing an alternative load path to the Load Cells during ballistic impacts.

1. A system for assessing the risk of injury or damage to an object in response to blunt impact, the model comprising a hollow shell, having an inner surface and an outer surface, defining the shape of the object, and a force sensor displayed at or beneath the inner surface of the hollow shell, wherein the force sensor is moveable to circumscribe the whole or a substantial part of the inner surface of the hollow shell to record a force at a point or area on or beneath the hollow shell.

2. A system according to claim 1 wherein the system is a blunt impact head injury model system for assessing skull fracture risk beneath a helmet in response to blunt impact conditions, wherein the hollow shell defines the shape of a human skull, or a part thereof, to support the helmet.

3. A blunt impact injury model system according to claim 2, wherein the shape of the hollow shell defines at least the frontal bone and the parietal bone, or a substantial part thereof, of the human skull.

4. A blunt impact injury model system according to claim 2, wherein the shape of the hollow shell defines at least the neurocranium, or a substantial part thereof, of the human skull.

5. A blunt impact injury model system according to claim 2, wherein the hollow shell is an artificial human skull.

6. A blunt impact injury model system according g to claim 1, wherein the hollow shell is comprised from materials able to transmit loads to the force sensor.

7. A blunt impact injury model system according to claim 6, wherein the hollow shell is comprised of high impact polystyrene (HIPS), polyester terephthalate glycol (PETG), acrylonitrile butadiene styrene (ABS), polypropylene (PP) or polyvinyl chloride (PVC).

8. A blunt impact injury model system according to claim 1, wherein the force sensor is mounted on a moveable arm.

9. A blunt impact injury model system according to claim 8, wherein the moveable arm is enclosed within the hollow shell.

10. A blunt impact injury model system according to claim 2, wherein the shape of the hollow shell is in accordance with an ISO standard head form.

11. A blunt impact injury model system according to claim 8, wherein the movable arm has five degrees of freedom of movement.

12. A blunt impact injury model system according to claims, wherein the force sensor is a load cell array.

13. Use of a force sensor for evaluating the response of a substantially flat sample of material to a blunt impact to enable selection of materials suitable for use in armour, wherein the flat sample of material has an inner surface and an outer surface and is arranged to experience a blunt impact to the outer surface, and the force sensor is displayed at or behind the inner surface to record a force at a point or area on or behind the flat sample of material.
